(19) United States
(12) Patent Application Publication
(10) Pub. No.: US 2014/0319172 A1
(43) Pub. Date: Oct. 30, 2014

(54) LIQUID REPLENISHMENT SYSTEM FOR A PRINTING APPARATUS FOR DEPOSITING A LIQUID COMPOSITION ON A BACKPLANE INCLUDING A DISPENSING VESSEL HAVING A CORRUGATED SECONDARY CONTAINER

(71) Applicant: E I DU PONT DE NEMOURS AND COMPANY, Wilmington, DE (US)

(72) Inventor: JAMES DANIEL TREMEL, SANTA BARBARA, CA (US)

(73) Assignee: E I DU PONT DE NEMOURS AND COMPANY, Wilmington, DE (US)

(21) Appl. No.: 14/265,895

(22) Filed: Apr. 30, 2014

Related U.S. Application Data
(60) Provisional application No. 61/817,593, filed on Apr. 30, 2013.

(51) Int. Cl. B05B 12/08; B65D 83/00

(52) U.S. Cl. CPC B05B 12/081; B65D 83/0094
USPC 222/56

(57) ABSTRACT

A liquid replenishment system responsive to a volume control signal representative of the volume of liquid within a secondary container disposed within a dispensing vessel. The secondary container is fabricated of a material that is impervious to a driving fluid contained within the interior chamber of the dispensing vessel. The secondary container has a pleated sidewall forming of a collapsible bellows configuration with a freely movable end formed of a rigid planar base. A volume sensor is responsive to changes in position of the freely movable end within the chamber to generate a signal representative of the volume of liquid composition within the secondary container.

### CLAIM OF PRIORITY

This application claims priority from the following U.S. Provisional Application, which is hereby incorporated by reference:

System and Process For Liquid Replenishment For A Printing Apparatus For Depositing A Liquid Composition On A Backplane, Application Ser. No. 61/773,532 filed 6 Mar. 2013 (UC-1200).

### CROSS REFERENCE TO RELATED APPLICATIONS

Subject matter disclosed herein is disclosed in the following copending applications, filed contemporaneously herewith and assigned to the assignee of the present invention:

Dispensing Vessel Having A Corrugated Secondary Container For Use In A Printing Apparatus For Depositing A Liquid Composition On A Backplane (UC-1229)

Dispensing Vessel Having A Self-Supporting Secondary Container For Use In A Printing Apparatus For Depositing A Liquid Composition On A Backplane (UC-1117); and

Liquid Replenishment System For A Printing Apparatus For Depositing A Liquid Composition On A Backplane Including A Dispensing Vessel Having A Self-Supporting Secondary Container (UC-1128).

### BACKGROUND OF THE INVENTION

1. Field of the Invention

This invention relates to a printing apparatus for depositing a liquid composition on a surface, such as the depositing of a liquid composition containing an organic semiconductor material on a backplane, and particularly to a system for replenishing the supply of the liquid composition and, in another particular aspect, to a dispensing vessel having a corrugated secondary container for storing a supply of the liquid composition.

2. Description of the Related Art

Organic electronic devices utilizing organic active materials are used in many different kinds of electronic equipment. The term “organic electronic device” is intended to mean a device, such as an organic light emitting diode (OLED), that includes one or more layers of organic semiconductor materials laminated between other supporting layers and sandwiched by two electrodes.

Current manufacture of organic electronic devices utilizes a vapor phase deposition process to deposit organic semiconductor materials. However, vapor phase deposition is believed to be disadvantageous owing to its poor utilization of materials. In vapor phase deposition a mask is used to control precise deposition of each layer of organic semiconductor material. The open areas of the mask allow material to adhere to desired areas of the underlying substrate. However, the solid portions of the mask become coated with organic semiconductor material during production of each layer and do not reach the substrate. This is seen as wasteful of the organic materials. In addition, masks must be replaced after only a few production cycles to maintain deposition quality. Scaling of the vapor phase deposition to larger electronic devices is problematic and expensive.

In view of these perceived difficulties liquid deposition of organic semiconductor materials is seen as an advantageous alternative.

With liquid deposition each organic material is carried in a liquid composition. During manufacture of a device each liquid composition is dispensed from a dedicated nozzle carried by a dispensing bar. The nozzles are grouped in nozzle sets, with one nozzle in each set dispensing a particular color of ink. Each nozzle dispenses liquid and deposits that liquid along a longitudinal lane that extends across a backplane of the device. The nozzles in each set continuously dispense a liquid composition into a respective lane as the bar traverses the backplane.

The individual nozzles for each particular color in each nozzle set are supplied as a group from a common manifold itself supplied from a suitable nozzle supply source, or supply reservoir. The supply reservoir for each particular color is usually implemented using a communal dispensing vessel. The dispensing vessel may either directly hold a supply of liquid for the nozzles or may hold a secondary container, such as a sealed pouch, containing the particularly colored liquid composition.

The dispensing vessel used in the prior art includes an outer shell, or can, that is closed in an air-tight manner by a conjoinable lid. When conjoined the can and lid cooperate to define an enclosed interior chamber. The interior chamber of the vessel contains an inert gas (e.g., nitrogen) that is held at a predetermined pressure above atmospheric pressure, typically a pressure level on the order of one hundred thirty pounds/square inch (130 psi; 0.9 MPa). The pressure of the inert gas in the interior chamber forces liquid from the outer can or from the secondary container to the manifold, and from the manifold, through a dedicated flow line to a nozzle. It is possible that the pressurized driving gas can permeate through the secondary container and dissolve into the liquid. This occurrence is seen as disadvantageous.

The holding capacity of the dispensing vessel or the secondary container is limited, requiring that liquid ink in the dispensing vessel or the secondary container be replenished as the liquid ink is consumed by the nozzles. Several factors serve to complicate ink replenishment.

Currently, replenishing ink in the supply reservoir requires a shut-down of the printer and termination of nozzle discharge. The dispensing vessel is depressurized and its lid removed. With the lid removed the dispensing vessel is recharged or the secondary container, if one is used, is either replaced or refilled. Once the dispensing vessel is replenished with liquid the lid is re-attached and the pressure vessel re-pressurized.

This arrangement and method for replenishing liquid is believed disadvantageous for several reasons.

On a system level care must be exercised to minimize the potential of nozzle failure due to plugging, which is more probable to occur during startup/shutdown phases than during steady operation of the system. The more often nozzles are turned off the greater is the chance for nozzle failure. Moreover, after starting a nozzle it takes a significant amount of time for the system to reach a steady flow rate. During this time ink discharged from the nozzle is not useable and is wasted.

The act of replacing or refilling of the secondary container if one is used (e.g., a pouch) involves additional specific challenges beyond the disadvantages caused by the time-consuming disconnection and re-connection of the pouch to its associated manifold. These challenges include maintaining the pouch's structural integrity, avoiding gas entrapment in any supply lines, avoiding the introduction of atmospheric gases into the pouch, and monitoring the volume of liquid introduced into the back to prevent overfill and potential rupture of the pouch.

U.S. Pat. No. 5,473,350 (Mader et al.) discloses a system and method for maintaining ink concentration in a printing system. However, in the system disclosed in this patent it appears that the main ink supply reservoir is maintained under partial vacuum, rather than at a pressure greater than atmospheric pressure.

In view of the foregoing it is believed advantageous to provide a system and process for continuously replenishing a liquid composition in a secondary container in the dispensing vessel serving as the nozzle supply source without requiring disconnection or de-pressurization. It is also believed to be advantageous to provide a supply reservoir implemented using a dispensing vessel with an improved form of secondary container therein which eliminates the possibility of driving gas dissolution into the liquid composition.

### SUMMARY OF THE INVENTION

The present invention is directed to a replenishment system that includes an improved dispensing vessel. The improved dispensing vessel serves as a nozzle supply reservoir providing liquid composition to a dispensing nozzle that deposits the liquid composition on a surface. The replenishment system is operable to replenish liquid at a predetermined pressure above atmospheric pressure to the nozzle supply reservoir.

The improved dispensing vessel comprises an outer shell, or can, that is closed in an air-tight manner by a conjoinable lid. When conjoined the can and lid cooperate to define an enclosed chamber. The cover has an interior surface presented toward the chamber. The cover has a replenishment liquid inlet port and a liquid supply outlet port extending therethrough.

A collapsible secondary container able to receive a volume of a liquid composition is disposed within the outer can. The collapsible secondary container is fabricated of a material, such as stainless steel, that is impervious to a driving fluid contained within the interior chamber of the dispensing vessel.

The secondary container has a freely movable end and a fixed end. The secondary container is attached to the interior surface of the cover such that the fixed end of the secondary container surrounds the replenishment liquid inlet port and the outlet port whereby the interior of the secondary container is in fluid communication with both these ports.

In a preferred instance the secondary container has a pleated body that forms a collapsible bellows. A rigid base forms the freely movable end of the bellows. The rigid base is preferably planar and is able to respond to a force imposed thereon by the driving fluid within the chamber to collapse the bellows and thereby to urge a liquid material present in the secondary container toward the outlet port in the lid.

A volume sensor is responsive to changes in position of the freely movable end of the bellows within the chamber to generate a signal representative of the volume of liquid within the secondary container. The volume sensor is preferably implemented using laser distance sensing device that directs a beam of radiation through a transparent window provided in the outer can toward the freely movable end of the bellows.

The replenishment system includes a volume control network that is operably responsive to the volume sensor to generate a volume control signal that is applied to a pump. The pump is operable to inject replenishment liquid drawn from a liquid replenishment source into the secondary container. The replenishment liquid is injected at a pressure at least substantially equal to the pressure of the liquid held in the secondary container and at a flow rate selectable in accordance with the volume control signal such that the volume of liquid in the secondary container is maintained at a predetermined reference level.

### BRIEF DESCRIPTION OF THE DRAWING

The invention will be more fully understood from the following detailed description, taken in connection with the accompanying drawing, which forms a part of this application and in which:

FIG. 1 is a highly stylized pictorial representation illustrating a liquid replenishment system for continuously replenishing liquid to a supply reservoir of a printing apparatus, the system including an improved dispensing vessel having a corrugated secondary container in accordance with one aspect of the present invention.

### DETAILED DESCRIPTION OF THE INVENTION

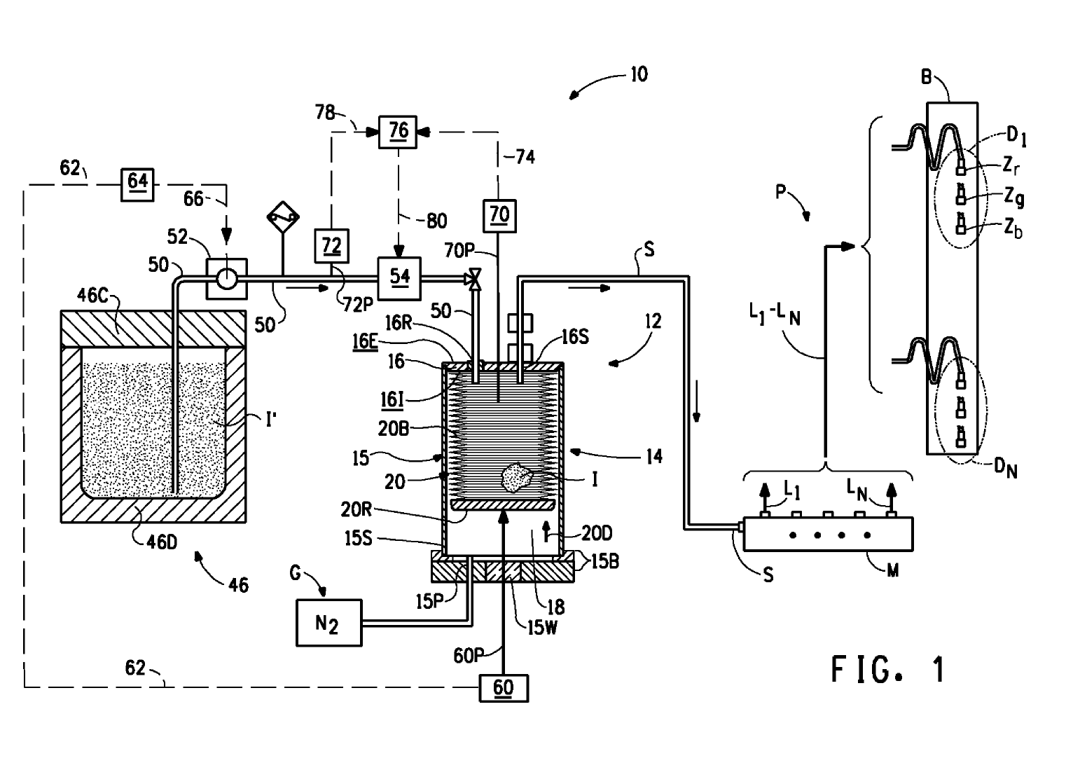

FIG. 1 is a highly stylized pictorial representation of a system generally indicated by the reference character 10 for continuously replenishing a supply source, or supply reservoir, supplying a liquid to dispensing nozzles in a printing apparatus, such as a printing apparatus useful to dispense a liquid composition onto the backplane of an organic electronic device. The nozzle supply reservoir is generally indicated by the reference character 12 and is implemented using a pressurizable dispensing vessel 14 structured in accordance with an aspect of the present invention.

The printing apparatus is generally indicated by the reference character P. Elements of the printing apparatus P common to the prior art are indicated herein by alphabetic reference characters. The printing apparatus is useful in the fabrication of various organic electronic devices, and is believed to be especially useful to fabricate screens for variously sized display devices, including high density display devices.

The printing apparatus P includes a dispensing bar B that carries N sets of dispensing nozzles, respectively indicated by the reference characters D₁, . . . D_{N}. Typically, a bar may carry five or more nozzle sets. Each nozzle set includes a separate nozzle that discharges one of a plurality of different colored liquid compositions. Typically, each nozzle set D may contain a nozzle Zᵣ, Z_{g}, and Z_{b} respectively dispensing a red, a green and a blue liquid composition.

The nozzle in each nozzle set for a given color, e.g., the nozzles Zᵣ in the nozzle sets D₁, . . . D_{N}, are supplied from a common manifold M. Thus, for example, each red nozzle Zᵣ is supplied over a dedicated line L₁, . . . L_{N} from a common manifold dispensing a red liquid composition. Similar plumbing is provided for the nozzles for the other colors, as the case may be. Each common manifold is itself supplied over a supply line S from its dedicated dispensing vessel 14.

The pressurizable dispensing vessel 14 in accordance with the present invention is implemented as a nested assembly that includes a rigid outer can 15 and a collapsible secondary container 20 received therein. The outer can 15 defined by a structural sidewall 15S (typically cylindrical in form) having an attached bottom 15B. The bottom 15B has a transparent section, or window, 15W formed therein, for a purpose to be described.

The open end of the can 15 is closed in an air-tight manner by a conjoinable lid 16. The lid 16 has an exterior surface 16E and an interior surface 161. When conjoined the outer can 15 and the lid 16 cooperate to define an enclosed interior chamber 18. The interior surface 161 of the lid 16 is presented to the chamber 18. The can 15 and the lid 16 as described are substantially similar to the members used to form a dispensing vessel in the prior art. However, in accordance with the present invention the lid 16 is modified to have a replenishment liquid inlet port 16R and a liquid supply outlet port 16S extending therethrough.

The liquid composition, or ink, I to be supplied to the manifold M (via the supply line S) and then to the nozzles is held in the secondary container 20 received in the interior chamber 18 of the outer can 15. When in use, the liquid ink I within the secondary container exhibits a given temperature and pressure profile consistent with the temperature and pressure within the pressurized outer can 15.

In use, the interior chamber 18 holds a pressurized inert driving fluid, such as nitrogen gas, therein. The gas is held at a predetermined pressure above atmospheric pressure. Typically the pressure level within the chamber 18 is on the order of one hundred thirty pounds/square inch (130 psi; 0.9 MPa). The gas is supplied from a gas supply arrangement G that communicates with the chamber 18 through a port 15P formed in the bottom 15B. Details of the gas supply arrangement G (including any appropriate pressure relief elements) are not shown in FIG. 1 for economy of illustration.

The secondary container 20 in accordance with the present invention is collapsible structure having a hollow sidewall, or body, 20B that is corrugated, or pleated, to impart a collapsible bellows configuration. The body 20B is fabricated of a material that is both compatible with the liquid composition being stored therein and impervious to the driving fluid within the chamber 18. Preferably, the secondary container 20 is fabricated of stainless steel, preferably AM350SS or similar stainless with high strength and excellent weldability, although any other suitable gas-impervious, liquid-compatible material may be used. The movable end of the body 20B is closed by a rigid planar base member 20R, also made of stainless steel. A collapsible bellows with rigid base suitable for use as the secondary container 20 may be obtained from BellowsTech, LLC., Ormond Beach, Fla.

The opposite, fixed, end of the body 20B is attached, as by welding, to the interior surface of the lid 161 such that the fixed end of the secondary container surrounds the inlet and the outlet ports 16R, 16S, respectively, in the lid 16. The interior of the secondary container 20 is thus in fluid communication with the replenishment liquid inlet port 16R and a liquid supply outlet port 16S. The free end of the nozzle supply pipe S (i.e., the end opposite the manifold M) extends through the liquid supply outlet port 16S in the lid 16 and projects for a predetermined distance into the interior of the secondary container 20.

The corrugated body 20B and rigid base member 20R are spaced from the interior surface of the can 15 so that the base 20R is freely movable and the bellows freely collapsible within the can. The rigid base 20R responds to a force imposed thereon by the driving gas within the chamber 18 by displacing in the direction 20D (toward the lid 16), thus collapsing the body 20B of the bellows and thereby urging the liquid material I present in the secondary container 20 toward the outlet port 16S, into the supply pipe S, and thence to the manifold M.

The replenishment system 10 is operable to continuously and automatically replenish the supply of ink I in the secondary container 20. To this end the replenishment system 10 includes a receptacle 46 that serves as a source of source of replenishment liquid I′. In the embodiment illustrated the receptacle 46 is implemented in the form of a drum 46D closed in an air-tight manner by an associated cap 46C. The interior of the receptacle 46 is typically at ambient temperature (i.e., temperature of the local environment) and at atmospheric pressure.

Replenishment liquid flow from the receptacle 46 is carried to the secondary container 20 by a supply line 50. One end of the supply line 50 projects into the receptacle 46. The opposite end of the line 50 passes through the replenishment supply port 16R in the cap 16 and projects a predetermined distance into the interior of the secondary container 20. A pump 52 and a heat exchanger 54 are connected in the supply line 50 for purposes to be described.

Suitable for use as the pump 52 is a high pressure liquid chromatography piston-type injection pump such as the Prep 100 Preparative Digital Pumps available from Chrom Tech, Inc., Apple Valley, Minn. This pump is controllable for flow rates in the range from 0.1 to 100 mL/min at pressures up to 4,000 psi. Other pump designs, such as a diaphragm pump or a gear pump may also be suitable. Whatever the form of pump used, it is important to avoid contamination of the liquid ink that the internal parts of the pump that are contacted by the replenishment liquid are fabricated from a non-elastomeric material, such as stainless steel, polytetrafluroethylene or sapphire.

A volume monitoring device, or volume sensor 60, is operable to monitor the volume of liquid in the secondary container 20 of the dispensing vessel 14 as the same is being depleted by the nozzles. The volume sensor 60 generates a signal representative of the volume of liquid I that is applied over a line 62 to a volume control network 64. In the embodiment illustrated the volume sensor 60 operates by monitoring the position of the movable free end 20R of the secondary container 20 within the chamber 18. The volume sensor 60 is responsive to changes in position of the free end 20R within the chamber 18 to generate a signal representative of the volume of liquid within the secondary container.

The volume sensor 60 may be implemented using a laser distance sensing device such as that sold by Keyence Corporation of America, Elmwood Park, N.J., as CCD Laser Displacement Sensor IL300. The sensor 60 is physically mounted in any convenient position such that radiation from the laser (diagrammatically indicated as an arrow 60P) passes through the window 15W. The radiation is reflected from the rigid member 20R and returns to the sensor 60. The distance between the sensor and the rigid member is calibrated with the volume within the secondary container 20. This distance changes as the liquid within the secondary container 20 is depleted.

In use, the volume control network 64 responds to the signal from the volume sensor 60 by generating a volume control signal that is output over a line 66 to the replenishment pump 52. The pump 52 draws replenishment liquid from the receptacle 46 and injects that replenishment liquid into the secondary container 20 at a pressure at least substantially equal to the pressure of the liquid in the container 20. The control network 64 selectably modifies the flow rate of replenishment liquid drawn by the pump 52 such that the volume of liquid in the container 20 is maintained at a predetermined desired reference level.

The volume control network 64 may be implemented using a programmable logic controller such as that available from Galil Motion Control, Rocklin, California as “RIO47200”. The controller implements implementing a proportional integral/differential algorithm.

The replenishment system 10 may further include a replenishment liquid temperature control system that includes temperature sensors 70, 72. The sensors respectively monitor the temperature of the liquid I in the secondary container 20 and the temperature of the replenishment liquid I′ being supplied thereto. In the arrangement illustrated in FIG. 1 the probe 70P from the sensor 70 extends in a sealed manner through the lid 16 into the secondary container 20. The sensor 70 is operable to monitor the temperature of the liquid I held in the secondary container 20 and provide a signal representative of the same over a line 74 to a temperature control network 76. Similarly, the probe 72P of the temperature sensor 72 is disposed to monitor the temperature of the replenishment liquid I′ in the line 50 and provide a signal representative thereof to the network 76 over a line 78. The sensors 70, 72 may be disposed in the system in any convenient alternative locations. Suitable for use as each temperature sensor is a high precision resistance temperature device element.

In use, the temperature control network 76 compares a signal representative of the temperature of a liquid I within the container 20 to a signal representative of the temperature of a replenishment liquid I′ and generates a temperature control signal when the comparison indicates that the temperature of the replenishment liquid I′ differs from the temperature the liquid I by a predetermined amount. The temperature signal is applied over a line 80 to the heat exchanger 54.

The heat exchanger 54 responds to the temperature control signal to adjust the temperature of replenishment liquid I′ injectable by the pump 52 to a temperature that lies within a predetermined range of the temperature of the liquid I in the container 20.

Although shown in the drawing as being disposed between the pump and the container 20, it should be understood that the heat exchanger 54 may be connected at any convenient position within the system 10. The heat exchanger 54 may be implemented using, for example, a thermoelectric heating/cooling module or an electric resistance heater.

It should be appreciated from the foregoing description that the positioning of the secondary container within the dispensing vessel permits the secondary container to be replenished without the necessity of its removal from the dispensing vessel. Fabricating the secondary container from a gas-impervious material eliminates the possibility of the pressurized driving gas within the chamber dissolving into the liquid composition.

Those skilled in the art, having the benefit of the teachings of the present invention, may impart modifications thereto. Such modifications are to be construed as lying within the scope of the present invention, as defined by the appended claims.

What is claimed is:

1. A liquid replenishment system for replenishing liquid composition in a dispensing vessel that supplies liquid composition to a printing apparatus, the dispensing vessel having a collapsible secondary container therein,
the liquid replenishment system comprising:
a receptacle for storing a replenishment liquid composition;
a volume sensor operable to generate a signal representative of the volume of liquid composition within the secondary container;
a volume control network operably associated with the volume sensor and responsive to the volume signal therefrom for generating a volume control signal; and
a pump responsive to the volume control signal, the pump being operable to inject a replenishment liquid from the receptacle into the secondary container at a pressure at least substantially equal to the pressure in the secondary container and at a flow rate selectable in accordance with the volume control signal such that the volume of liquid composition in the secondary container is maintained at a predetermined reference level;
wherein the dispensing vessel itself comprises:
a outer can and corresponding lid, the lid being conjoinable to the outer can in an air-tight manner, when conjoined the outer can and lid cooperating to define an enclosed chamber, the lid having an exterior surface and an interior surface, the lid having a replenishment liquid inlet port and a liquid supply outlet port being formed therethrough, the replenishment liquid inlet port being connected to the pump,
in use, the interior chamber having a pressurized driving fluid therein, the pressurized driving fluid being able to collapse the secondary container to force a liquid composition therefrom; and wherein
the dispensing vessel is improved in that:
the secondary container is fabricated of a material that is impervious to a driving fluid contained within the interior chamber of the dispensing vessel,
the secondary container having a fixed end and a freely movable end, the secondary container being attached to the interior surface of the lid such that the fixed end of the secondary container surrounds the replenishment liquid inlet port and the outlet port in the lid, whereby the interior of the secondary container is in fluid communication with both the replenishment liquid inlet port and the outlet port.

2. The liquid replenishment system of claim 1 wherein the volume sensor is responsive to changes in position of the freely movable end of the secondary container within the chamber to generate a signal representative of the volume of liquid within the secondary container.

3. The liquid replenishment system of claim 1 wherein the secondary container has a pleated body that imparts a collapsible bellows configuration to the secondary container.

4. The liquid replenishment system of claim 3 wherein the movable end of the secondary container has a rigid base responsive to a force imposed thereon by a driving fluid to collapse the bellows and to urge a liquid composition present in the secondary container toward the outlet port in the lid.

5. The liquid replenishment system of claim 4 wherein the base of the secondary container is planar.

6. The liquid replenishment system of claim 5 wherein the base of the secondary container is fabricated from stainless steel.

7. The liquid replenishment system of claim 3 wherein the body of the secondary container is fabricated from stainless steel.

8. The liquid replenishment system of claim 1 wherein the secondary container is fabricated from stainless steel.

9. The liquid replenishment system of claim 5 wherein the volume sensor is responsive to changes in position of the movable end of the secondary container within the chamber to generate a signal representative of the volume of liquid composition within the secondary container.

6. The liquid replenishment system of claim 4 wherein the outer can of the dispensing vessel has a transparent window formed therein, and wherein
the volume sensor comprises:
a source of laser radiation operable to transmit a beam of radiation,
the source being positioned with respect to the outer can such that the beam of radiation passes through the transparent window.
